(19) United States
(12) Patent Application Publication
(10) Pub. No.: US 2024/0425709 A1
(43) Pub. Date: Dec. 26, 2024

(54) ULTRAVIOLET-ABSORBING RESIN COMPOSITION, ULTRAVIOLET-ABSORBING RESIN AND PREPARATION METHOD THEREOF

(71) Applicant: PLATINUM OPTICS TECHNOLOGY INC., Taoyuan City (TW)

(72) Inventors: Shih-Song Cheng, Taoyuan City (TW); Hung-Han Duan, Taoyuan City (TW); Bo-Xun Zhu, Taoyuan City (TW); Jia-Cheng Chang, Taoyuan City (TW); Kuan-Yu Chen, Taoyuan City (TW); Shi-Lin Zhang, Taoyuan City (TW)

(73) Assignee: PLATINUM OPTICS TECHNOLOGY INC., Taoyuan City (TW)

(21) Appl. No.: 18/743,888

(22) Filed: Jun. 14, 2024

(30) Foreign Application Priority Data
Jun. 16, 2023 (TW) 112122742

(51) Int. Cl. C09D 5/32; C09D 7/20; C09D 7/41; C09D 7/63; C09D 127/12; G02B 1/04; G02B 5/20

(52) U.S. Cl. CPC C09D 5/32; C09D 7/20; C09D 7/41; C09D 7/63; C09D 127/12; G02B 1/04; G02B 5/208

(57) ABSTRACT

Provided is an ultraviolet-absorbing resin composition, including 35 to 45 wt % of a fluorocarbon resin, 5 to 25 wt % of an isocyanate curing agent, 1 to 5 wt % of an ultraviolet absorbent, and a residual solvent accounting for the balance, based on the total weight of the ultraviolet-absorbing resin composition. Provided is also an ultraviolet-absorbing resin, an ultraviolet-absorbing structure including the same, and the method for preparing the same. The present disclosure obtains an ultraviolet-absorbing resin with a specific composition from a specific resin composition formula, and the ultraviolet-absorbing resin efficiently absorbs ultraviolet and has excellent visible light transmittance, as well as high stability.

### CROSS-REFERENCE TO RELATED APPLICATION

This application claims the benefit of priority of Taiwan Patent Application No. 112122742, filed Jun. 16, 2023, the entire contents of which are hereby incorporated by reference.

### BACKGROUND

### Technical Field

The present disclosure relates to an ultraviolet-absorbing resin, including a fluorocarbon resin, an isocyanate curing agent, and an ultraviolet absorbent, which is formed from a specific resin composition, and also relates to an ultraviolet-absorbing structure including a plurality of ultraviolet-absorbing resin layers.

### Description of Related Art

Long-term exposure to ultraviolet rays has adverse effects on devices, therefore, in devices such as sensing components, computers, communication products, consumer electronics, and automotive products, components that can filter ultraviolet rays are usually installed. For example, ultraviolet filters are widely used in optical devices. Ultraviolet filters in optical devices are generally required to have a significant cut-off effect on ultraviolet rays and to exhibit good transmittance for visible light.

The filtering effect of an ultraviolet filter may deteriorate with time, and it is necessary to protect the ultraviolet absorbent in the ultraviolet filter through a substrate to improve the ultraviolet tolerance/stability. Conventional techniques have reported using epoxy resin and acrylic resin as the main resin layer to protect the ultraviolet absorbent therein. However, this ultraviolet filter failed to pass the 1000 hr ultraviolet resistance test, and its performance still needs to be improved. On the other hand, when using those resins, due to the high process temperature, the substrate during coating and film formation must also withstand high temperatures, as a result, the selectivity of the substrate is limited and the application market cannot be expanded.

### SUMMARY

To address the above problems, the present disclosure provides an ultraviolet-absorbing resin composition, which can form an ultraviolet-absorbing resin after being processed such as drying and curing, wherein the ultraviolet-absorbing resin composition includes a fluorocarbon resin with a protective function, an isocyanate curing agent, an ultraviolet absorbent and a solvent.

In the ultraviolet-absorbing resin composition of the present disclosure, based on the total weight of the ultraviolet-absorbing resin composition, the fluorocarbon resin accounts for 35 wt % to 45 wt %, the isocyanate curing agent accounts for 5 wt % to 25 wt %, and the ultraviolet absorbent accounts for 1 wt % to 5 wt %, while the solvent is the balance. In embodiments, the fluorocarbon resin accounts for about 35 wt % to about 45 wt %, the isocyanate curing agent accounts for about 5 wt % to about 25 wt %, and the ultraviolet absorbent accounts for about 1 wt % to about 5 wt %, while the solvent is the balance.

In one embodiment, the fluorocarbon resin includes fluorinated ethylene repeating units as shown in Formula 1,

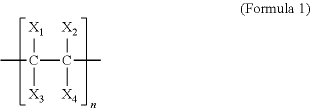

wherein, X₁, X₂, X₃ and X₄ are each independently hydrogen, fluorine, substituted or unsubstituted C₁-C₁₂ alkyl, substituted or unsubstituted C₃-C₁₂ cycloalkyl, substituted or unsubstituted C₆-C₁₂ aryl, n is any positive integer, and at least one of X₁, X₂, X₃ and X₄ is fluorine or substituted by fluorine.

In one embodiment, the fluorocarbon resin includes a second repeating unit that is different from the fluorinated ethylene repeating unit.

In one embodiment, the isocyanate curing agent is selected from at least one of the group consisting of hexamethylene diisocyanate (HDI), toluene diisocyanate (TDI), cyclohexane diisocyanate (CHDI), isophorone diisocyanate (IPDI), methylene diphenyl diisocyanate (MDI), methylene dicyclohexyl diisocyanate (H₁₂MDI), naphthalene diisocyanate (NDI), trimethylhexamethylene diisocyanate (TMDI), xylene diisocyanate (XDI), lysine diisocyanate (LDI), trimer of the said diisocyanate, triphenylmethane triisocyanate, toluene triisocyanate, and lysine triisocyanate.

In one embodiment, ultraviolet absorbent is selected from at least one of the group consisting of azomethine compounds, indole compounds, benzotriazole compounds, triazine compounds, ketone compounds, and salicylic acid derivatives.

In one embodiment, the ultraviolet-absorbing resin composition further comprises a solvent. In another embodiment, the ultraviolet-absorbing resin composition further includes a light stabilizer.

In one embodiment, the ultraviolet-absorbing resin composition includes fluorocarbon resin; hexamethylene diisocyanate (HDI) as an isocyanate curing agent; benzotriazole compounds as ultraviolet absorbents; and xylene and methyl ethyl ketone as solvents.

In one embodiment, the ultraviolet-absorbing resin composition includes 0.01 wt % to 2 wt % light stabilizers; fluorocarbon resin; toluene diisocyanate (TDI) as an isocyanate curing agent; benzotriazole compounds as ultraviolet absorbents; and xylene as solvents.

The present disclosure further provides an ultraviolet-absorbing resin, which can be formed from the ultraviolet-absorbing resin composition described herein.

In one embodiment, the ultraviolet-absorbing resin comprises a fluorocarbon resin, an isocyanate curing agent, and an ultraviolet absorbent.

In one embodiment, the fluorocarbon resin of the ultraviolet-absorbing resin includes a fluorinated ethylene repeating unit as shown in Formula 1,

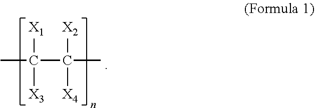

Wherein, X₁, X₂, X₃ and X₄ are each independently hydrogen, fluorine, substituted or unsubstituted C₁-C₁₂ alkyl, substituted or unsubstituted C₃-C₁₂ cycloalkyl, substituted or unsubstituted C₆-C₁₂ aryl, n is any positive integer, and wherein at least one of X₁, X₂, X₃ and X₄ is fluorine or substituted by fluorine.

In one embodiment, the isocyanate curing agent of the ultraviolet-absorbing resin is selected from at least one of the group consisting of hexamethylene diisocyanate (HDI), toluene diisocyanate (TDI), cyclohexane diisocyanate (CHDI), isophorone diisocyanate isocyanate (IPDI), methylene diphenyl diisocyanate (MDI), methylene dicyclohexyl diisocyanate (H12MDI), naphthalene diisocyanate (NDI), trimethylhexamethylene diisocyanate (TMDI), xylene diisocyanate (XDI), lysine diisocyanate (LDI), trimer of the above diisocyanates, triphenylmethane triisocyanate, toluene triisocyanate, lysine triisocyanate.

In one embodiment, the average transmittance of the ultraviolet-absorbing resin for light with a wavelength of 430 nm to 680 nm is 85% or more; and for light with a wavelength of 380 nm to 410 nm, the maximum light transmittance is 1% or less and the average transmittance is 1% or less. In one embodiment, the average transmittance of the ultraviolet-absorbing resin for light with a wavelength of 430 nm to 680 nm is about 85% or more; and for light with a wavelength of 380 nm to 410 nm, the maximum light transmittance is about 1% or less and the average transmittance is about 1% or less.

In one embodiment, after the ultraviolet-absorbing resin is tested at a high temperature of 85° C. and high humidity of 85% for 500 hours, the average transmittance for light with a wavelength of 430 nm to 680 nm is 85% or more; and for light with a wavelength of 380 nm to 410 nm, the maximum light transmittance is 1% or less and the average transmittance is 1% or less.

In one embodiment, after the ultraviolet-absorbing resin is tested at a high temperature of 85° C. and high humidity of 85% for 1,000 hours, the average transmittance for light with a wavelength of 430 nm to 680 nm is 85% or more; and the maximum light transmittance for light with a wavelength of 380 nm to 410 nm is 1% or less and the average transmittance is 1% or less.

The present disclosure also provides an ultraviolet-absorbing structure, comprising a plurality of ultraviolet-absorbing resin layers, wherein each of the ultraviolet-absorbing resin layers comprises the ultraviolet-absorbing resin described herein, and the isocyanate curing agents of the ultraviolet-absorbing resins in each layer are different from each other.

In one embodiment, each ultraviolet-absorbing resin layer of the ultraviolet-absorbing structure is prepared from the ultraviolet-absorbing resin composition described herein.

In one embodiment, the ultraviolet-absorbing structure comprises two ultraviolet-absorbing resin layers, wherein the isocyanate curing agent of the first ultraviolet-absorbing resin layer is hexamethylene diisocyanate (HDI), and the isocyanate curing agent of the second ultraviolet-absorbing resin layer is toluene diisocyanate (TDI).

In one embodiment, each ultraviolet-absorbing resin layer in the ultraviolet-absorbing structure has a thickness of 1 μm to 100 μm. In another embodiment, the ultraviolet-absorbing structure has a thickness of 2 μm to 200 μm.

The present disclosure also provides a method for preparing an ultraviolet-absorbing resin, which comprises coating the ultraviolet-absorbing resin composition described herein on the surface of a substrate; and curing the ultraviolet-absorbing resin composition to obtain an ultraviolet-absorbing resin.

In one embodiment, a method for preparing an ultraviolet-absorbing resin further comprises a step of repeatedly coating and curing the ultraviolet-absorbing resin composition on the ultraviolet-absorbing resin layer, to form a plurality of ultraviolet-absorbing resin layers.

In one embodiment, the isocyanate curing agent of the ultraviolet-absorbing resin composition that is repeatedly coated and cured is different from the isocyanate curing agent of the ultraviolet-absorbing resin composition that is coated on the surface of the substrate.

In one embodiment, the substrate is glass or cellulose triacetate film.

In one embodiment, the coating is spin coating, dip coating, cast coating, spray coating, bead coating, rod coating, blade coating or slit coating.

In one embodiment, the curing is performed at a temperature of 100° C. to 150° C. for 10 minutes to 60 minutes.

### BRIEF DESCRIPTIONS OF THE DRAWINGS

FIG. 1A is a schematic structural diagram of an exemplary finished product including the ultraviolet-absorbing resin of the present disclosure.

FIG. 1B is a schematic structural diagram of another exemplary finished product including the ultraviolet-absorbing resin (ultraviolet-absorbing structure) of the present disclosure.

FIG. 2 is the gloss retention rate of various exemplary substrate resins after being irradiated by QUV-A (Q-Lab ultraviolet accelerated) ultraviolet irradiation instrument.

FIG. 3A is a graph of the transmittance of exemplary ultraviolet-absorbing resins containing various isocyanate curing agents under the ultraviolet resistance test. HDI: hexamethylene diisocyanate; IPDI: isophorone diisocyanate; XDI: xylene diisocyanate; and TDI: toluene diisocyanate. T₀: ultraviolet irradiation for 0 hours; and T₂₄₀: ultraviolet irradiation for 240 hours.

FIG. 3B is a graph of the transmittance of exemplary ultraviolet-absorbing resins containing various isocyanate curing agents under the high temperature and high humidity (HTHH) weather resistance test. HDI: hexamethylene diisocyanate; IPDI: isophorone diisocyanate; XDI: xylene diisocyanate; TDI: toluene diisocyanate. T₀: ultraviolet irradiation for 0 hours; and T₅₀₀: ultraviolet irradiation for 500 hours.

FIG. 4A is a graph of the transmittance of the exemplary ultraviolet-absorbing resin of Example 1, Example 2 and Comparative Example 3 under the ultraviolet tolerance test. To: ultraviolet irradiation for 0 hours; T₂₄₀: ultraviolet irradiation for 240 hours; and T₁₀₀₀: ultraviolet irradiation for 1000 hours.

FIG. 4B is a graph of the transmittance of the ultraviolet-absorbing resin of Example 1, Example 2 and Comparative Example 3 in the high temperature and high humidity weather resistance test. T₀: ultraviolet irradiation for 0 hours; and T₅₀₀: ultraviolet irradiation for 500 hours.

### DETAILED DESCRIPTION

The following describes the implementation of the present disclosure through specific embodiments, a person having ordinary skill in the art can easily understand the scope and effect of the present disclosure based on the content recorded herein.

It should be noted that the structures, proportions, sizes, etc. shown in the drawings attached to this specification are only used to exemplify the content disclosed in the specification for the understanding and reading of people skilled in this art, and are not intended to limit the scope of the present disclosure. The present disclosure may also be implemented or applied as described in the various examples. It is also possible to modify or alter the following examples for carrying out the present disclosure without violating its spirit and scope, for different aspects and applications. One of skill in the art will appreciate that structural modifications, changes in proportions, or adjustments in size of the disclosed embodiments will fall within the scope of the technical content disclosed in the present disclosure without affecting the effects that can be produced and the purposes that can be achieved by the present disclosure.

At the same time, terms such as “above”, “first”, “second”, etc. cited in this specification are only for the convenience of description and are not used to limit the scope of the present disclosure, changes or adjustments in their relative relationships, provided there is no substantial change in the technical content, shall also be deemed to be within the scope of the present disclosure.

When “comprises”, “includes” or “having” specific elements are used herein, unless otherwise stated, other elements, components, structures, regions, locations, devices, systems, steps or connections may be included rather than excluded.

Unless otherwise expressly stated herein, the singular forms “a”, “an” and “the” used herein also include the plural forms, and the words “or” and “and/or” used herein may be used interchangeably.

The numerical ranges described herein are inclusive and combinable, and any numerical value falling within the numerical ranges described herein can be used as a maximum value or a minimum value to derive a sub-range; for example, the numerical range of “5 to 25” should be understood to include any sub-range between endpoint 5 and endpoint 25, such as 5 to 15, 10 to 25, 10 to 15 . . . and other sub-ranges; in addition, if a value falls within the ranges described herein (such as between the maximum value and the minimum value), it should be deemed to be included in the scope of the present disclosure.

The first aspect of the present disclosure is an ultraviolet-absorbing resin composition, including a fluorocarbon resin, an isocyanate curing agent, an ultraviolet-absorbent, and a solvent.

The fluorocarbon resin is mainly used as a base resin to protect the ultraviolet absorbent therein. Exemplary fluorocarbon resins include, but are not limited to, fluorinated ethylene repeating units, such as monofluoroethylene, difluoroethylene, trifluoroethylene, and tetrafluoroethylene. On the other hand, in addition to being substituted by fluorine atoms, the fluorinated ethylene repeating units can also be substituted by other groups, or modified, grafted, etc., so as to have diversified side chains. For example, the hydrogen atoms of fluorinated ethylene are substituted with alkyl groups to have side chains, so that the fluorinated ethylene repeating units become fluorinated propylene repeating units, fluorinated butylene repeating units, fluorinated styrene repeating units, etc.

In one embodiment, the fluorocarbon resin includes fluorinated ethylene repeating units as shown in Formula 1,

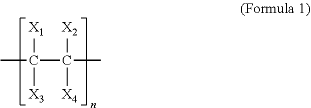

wherein, X₁, X₂, X₃ and X₄ are each independently hydrogen, fluorine, substituted or unsubstituted C₁-C₁₂ alkyl, substituted or unsubstituted C₃-C₁₂ cycloalkyl, substituted or unsubstituted C₆-C₁₂ aryl, and n is any positive integer, wherein at least one of X₁, X₂, X₃ and X₄ is fluorine or substituted by fluorine.

The C₁-C₁₂ alkyl, for example is methyl, ethyl, n-propyl, isopropyl, n-butyl, isobutyl, sec-butyl, tert-butyl, pentyl; the C₃-C₁₂ cycloalkyl group is, for example, cyclopropyl and cyclobutyl; the C₆-C₁₂ aryl group is, for example, phenyl, tolyl, and naphthyl. The substitution includes, for example, hydrogen atoms being substituted by substituents such as fluorine, C₁-C₁₂ alkyl, C₃-C₁₂ cycloalkyl, C₆-C₁₂ aryl and the like.

In one embodiment, the fluorocarbon resin includes a second repeating unit that is different from the fluorinated ethylene repeating unit.

In one embodiment, the fluorocarbon resin is polyvinyl fluoride (PVF), polyvinylidene fluoride (PVDF), polytetrafluoroethylene (PTFE), poly(ethylene-co-tetrafluoroethylene) (ETFE), perfluoroalkoxy alkane polymers (PFA) or fluorinated ethylene propylene (FEP).

In one embodiment, the second repeating unit is an alkyl vinyl ether repeating unit. In another embodiment, the fluorocarbon resin is perfluoroethyl vinyl ether (PEVE) type fluorocarbon resin, wherein X₁, X₂ and X₃ in Formula 1 are fluorine, X₄ is a substituted or unsubstituted C₁-C₁₂ alkyl group, a substituted or unsubstituted C₃-C₁₂ cycloalkyl group, a substituted or unsubstituted C₆-C₁₂ aryl group, and the alkyl vinyl ether repeating unit is —(CHR₁—CHOR₂)—, and R₁ and R₂ are hydrogen, substituted or unsubstituted C₁-C₁₂ alkyl, substituted or unsubstituted C₃-C₁₂ cycloalkyl.

In addition to the function of curing the ultraviolet-absorbing resin composition, the isocyanate curing agent in the present disclosure also helps to provide the obtained ultraviolet-absorbing resin with functions of light resistance and high temperature and high humidity resistance. The isocyanate curing agent can be selected from at least one of the group consisting of hexamethylene diisocyanate (HDI), toluene diisocyanate (TDI), cyclohexane diisocyanate (CHDI), isophorone diisocyanate isocyanate (IPDI), methylene diphenyl diisocyanate (MDI), methylene dicyclohexyl diisocyanate (H12MDI), naphthalene diisocyanate (NDI), trimethylhexamethylene diisocyanate (TMDI), xylene diisocyanate (XDI), lysine diisocyanate (LDI), trimer of the above diisocyanates, triphenylmethane triisocyanate, toluene triisocyanate, lysine triisocyanate. In one embodiment, the isocyanate curing agent is hexamethylene diisocyanate (HDI). In another embodiment, the isocyanate curing agent is toluene diisocyanate (TDI).

The ultraviolet absorbent in the present disclosure mainly absorbs light with a wavelength of 380 nm to 410 nm, which can convert ultraviolet light energy into heat energy or other non-destructive longer wavelengths, thereby effectively protecting the device from interference and damage by ultraviolet rays. Applicable devices include sensing components, computers, communication products, consumer electronics and automotive products, as well as those devices that are exposed to ultraviolet light for a long time. The ultraviolet absorbent may use at least one selected from the group consisting of azomethine compounds, indole compounds, benzotriazole compounds, triazine compounds, ketone compounds, and salicylic acid derivatives. In one embodiment, the ultraviolet absorbent is a benzotriazole compound.

In one embodiment, the ultraviolet-absorbing resin composition of the present disclosure may further include a light stabilizer, which is mainly used to repair the area of the ultraviolet-absorbing resin composition disclosed herein that is photo-oxidatively decomposed due to ultraviolet rays, so as to assist the ultraviolet absorbent. The light stabilizer can use hindered amine light stabilizers (HALS). Specifically, monomolecular hindered amine light stabilizers, polymeric hindered amine light stabilizers or low-alkaline hindered amine light stabilizers, such as 2,2,6,6-tetramethyldine derivatives, can be used.

In the present disclosure, based on the total weight of the ultraviolet-absorbing resin composition, the fluorocarbon resin accounts for 35 to 45 wt %, the isocyanate curing agent accounts for 5 to 25 wt %, the ultraviolet absorbent accounts for 1 to 5 wt %, and the remainder is the solvent. In one embodiment, the weight of the fluorocarbon resin is between 35 wt % and 45 wt %, including but not limited to 35 wt %, 36 wt %, 37 wt %, 38 wt %, 39 wt %, 40 wt %, 41 wt %, 42 wt %, 43 wt %, 44 wt % and/or 45 wt %. In one embodiment, the weight of the isocyanate curing agent is between 5 wt % and 25 wt %, including but not limited to 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt % and/or 25 wt %. In one embodiment, the weight of the ultraviolet absorbent is between 1 wt % and 5 wt %, including but not limited to 1 wt %, 1.5 wt %, 2 wt %, 2.5 wt %, 3 wt %, 3.5 wt %, 4 wt %, 4.5 wt % and/or 5 wt %.

In one embodiment, the solvent of the ultraviolet-absorbing resin composition is not limited, and conventional solvents can be selected, including but not limited to water, alcohols, ketones, ethers, esters, aromatic hydrocarbons, halogenated hydrocarbons, dimethyl formamide, dimethyl acetamide, dimethyl styrene, cyclobutane, etc. Specifically, the alcohols are, for example, methanol, ethanol, propanol, etc. The ketones are, for example, acetone, butanone, etc. The esters are, for example, alkyl formate, alkyl acetate, alkyl propionate, alkyl butyrate, alkyl lactate, alkyl alkoxyacetate, alkyl 3-alkoxypropionate, alkyl 2-alkoxypropionate, 2-alkoxy-2-methylpropionic acid alkyl ester, pyruvate alkyl ester, acetoacetic acid alkyl ester, 2-oxobutyric acid alkyl ester, etc. The ethers are, for example, diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl ether acetate, propylene glycol monopropyl ether acetate, etc. The ketones are, for example, methyl ethyl ketone, cyclohexanone, cyclopentanone, 2-heptanone, 3-heptanone, etc. The aromatic hydrocarbons are, for example, toluene, xylene, etc. In one embodiment, the solvent is a mixed solvent of xylene and methyl ethyl ketone. In another embodiment, the solvent is xylene.

In one embodiment, the weight of the solvent in the ultraviolet-absorbing resin composition of the present disclosure is not limited. However, as an example, based on the total weight of the ultraviolet-absorbing resin composition, the weight of the solvent is between 25 wt % to 59 wt %, including but not limited to 25 wt %, 30 wt %, 35 wt %, 40 wt %, 45 wt %, 50 wt %, 55 wt %, 59 wt %. The solvent may be a single solvent or a mixed solvent. In one embodiment, the solvent is a mixed solvent, which includes a first solvent and a second solvent, and the first solvent is 15 wt % to 25 wt %, including but not limited to 15 wt %, 16 wt %, 17 wt %, 18 wt %, 19 wt %, 20 wt %, 21 wt %, 22 wt %, 23 wt %, 24 wt % and/or 25 wt %, wherein the second solvent is 20 wt % to 25 wt %, including but not limited to 20 wt %, 21 wt %, 22 wt %, 23 wt %, 24 wt % and/or 25 wt %. In another embodiment, the solvent is a single solvent and the weight is 40 wt % to 45 wt %, including but not limited to 40 wt %, 41 wt %, 42 wt %, 43 wt %, 44 wt % and/or 45 wt %.

In one embodiment, the ultraviolet-absorbing resin composition of the present disclosure includes fluorocarbon resin; hexamethylene diisocyanate (HDI) as an isocyanate curing agent; benzotriazole compounds as ultraviolet absorbents; as well as xylene and methyl ethyl ketone as solvents. In another embodiment, the ultraviolet-absorbing resin composition of the present disclosure includes fluorocarbon resin; toluene diisocyanate (TDI) as an isocyanate curing agent; benzotriazole compounds as ultraviolet absorbents; and xylene as solvent.

In one embodiment, the ultraviolet-absorbing resin composition of the present disclosure can be in the form of a dispersion, wherein the ultraviolet-absorbent is evenly dispersed in the ultraviolet-absorbing resin composition to avoid deterioration of the ultraviolet cut-off effect and haze caused by condensation.

The second aspect of the present disclosure is an ultraviolet-absorbing resin, which can be formed from the ultraviolet-absorbing resin composition of the present disclosure. Specifically, the ultraviolet-absorbing resin includes a fluorocarbon resin, an isocyanate curing agent, and a ultraviolet-absorbent. Herein, the types of the fluorocarbon resin, the isocyanate curing agent, and the ultraviolet absorbent of the ultraviolet-absorbing resin are those described in the first aspect.

In one embodiment, the ultraviolet-absorbing resin of the present disclosure can be obtained from the ultraviolet-absorbing resin composition of the first aspect herein. For example, the ultraviolet-absorbing resin composition is dried and cured to obtain the ultraviolet-absorbing resin.

In one embodiment, the ultraviolet-absorbing resin of the present disclosure includes a fluorocarbon resin; hexamethylene diisocyanate (HDI) as an isocyanate curing agent; and a benzotriazole ultraviolet absorbent. In another embodiment, the ultraviolet-absorbing resin of the present disclosure includes a fluorocarbon resin; toluene diisocyanate (TDI) as an isocyanate curing agent; and a benzotriazole ultraviolet absorbent.

In one embodiment, the average transmittance of the ultraviolet-absorbing resin for incident light with a wavelength range of 430 nm to 680 nm is 85% or more, such as 85%, 86%, 87%, 88%, 89%, 90%, 91%, 92%, 93%, 94%, 95%, 96%, 97%, 98%, 99%; for light with a wavelength of 380 nm to 410 nm, the maximum light transmittance is 1% or less, such as 1%, 0.9%, 0.8%, 0.7%, 0.6%, 0.5%, and the average penetration rate is 1% or less, such as 1%, 0.9%, 0.8%, 0.7%, 0.6%, 0.5%.

In one embodiment, after the ultraviolet-absorbing resin is tested at a high temperature of 85° C. and high humidity of 85% for 500 hours, the average transmittance for light with a wavelength of 430 nm to 680 nm is 85% or more, such as 85%, 86%, 87%, 88%, 89%, 90%, 91%, 92%, 93%, 94%, 95%, 96%, 97%, 98%, 99%; for light with a wavelength of 380 nm to 410 nm, the maximum light transmittance is 1% or less, such as 1%, 0.9%, 0.8%, 0.7%, 0.6%, 0.5%, and the average transmittance is 1% or less, such as 1%, 0.9%, 0.8%, 0.7%, 0.6%, 0.5%.

In one embodiment, after the ultraviolet-absorbing resin is tested at a high temperature of 85° C. and high humidity of 85% for 1000 hours, the average transmittance for light with a wavelength of 430 nm to 680 nm is 85% or more, such as 85%, 86%, 87%, 88%, 89%, 90%, 91%, 92%, 93%, 94%, 95%, 96%, 97%, 98%, 99%; for light with a wavelength of 380 nm to 410 nm, the maximum light transmittance is 1% or lee, such as 1%, 0.9%, 0.8%, 0.7%, 0.6%, 0.5%, and the average transmittance is 1% or less, such as 1%, 0.9%, 0.8%, 0.7%, 0.6%, 0.5%.

The third aspect of the present disclosure is an ultraviolet-absorbing structure, including a plurality of layers of ultraviolet-absorbing resin layers, wherein each of the ultraviolet-absorbing resin layers includes the ultraviolet-absorbing resin layer as described in the second aspect. In one embodiment, the isocyanate curing agents of the ultraviolet-absorbing resins in each layer are different from each other.

In one embodiment, the plurality of layers is, for example, 2 layers, 3 layers, 4 layers or more. In one embodiment, the plurality of layers is 2 layers. In another embodiment, the plurality of layers is two layers, and the isocyanate curing agent of the first ultraviolet-absorbing resin layer is hexamethylene diisocyanate (HDI), and the isocyanate curing agent of the second ultraviolet-absorbing resin layer is toluene diisocyanate (TDI).

In one embodiment, the thickness of each ultraviolet-absorbing resin layer in the ultraviolet-absorbing structure is 1 μm to 100 μm, including but not limited to 1 μm, 5 μm, 10 μm, 20 μm, 30 μm, 40 μm, 50 μm, 60 μm, 70μ, 80 μm, 90 μm, 100 μm. In one embodiment, the thickness of the ultraviolet-absorbing structure is 2 μm to 200 μm, including but not limited to 2 μm, 5 μm, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, and/or 200 μm.

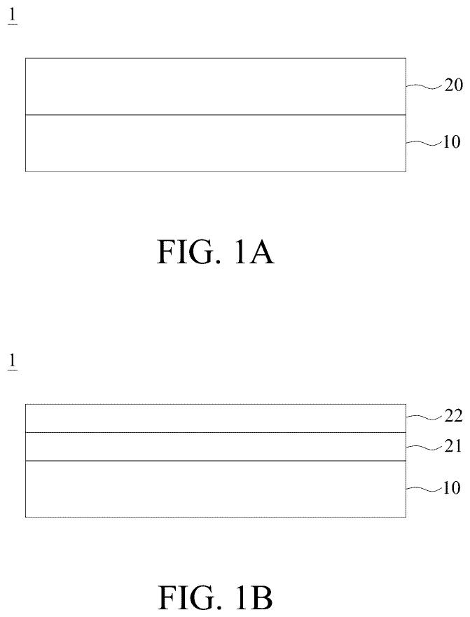

The fourth aspect of the present disclosure is a method for preparing an ultraviolet-absorbing resin, which includes coating the ultraviolet-absorbing resin composition described herein on the surface of a substrate; and curing the ultraviolet-absorbing resin composition to obtain an ultraviolet-absorbing resin. As shown in FIG. 1A, the ultraviolet-absorbing resin composition is coated on the surface of substrate 10, the ultraviolet-absorbing resin composition is cured to become ultraviolet-absorbing resin 20, and finally, the finished product 1 including the ultraviolet-absorbing resin is obtained.

In one embodiment, the preparation method of the present disclosure further includes mixing a fluorocarbon resin, an isocyanate curing agent, an ultraviolet absorbent and a solvent to form a composition. Herein, the types and amounts of each material are as described above.

The coating is not limited, as long as the composition can be evenly coated on the surface of the substrate, the coating method is included in the scope of the present disclosure. In one embodiment, coating is spin coating, dip coating, cast coating, spray coating, bead coating, rod coating, knife coating or slot coating.

The substrate is not limited, and any article with a surface that can be coated is included in the scope of the present disclosure, including semi-finished products and finished products. In one embodiment, the substrate is glass, a triacetate cellulose (TAC) film, or a plastic film such as PET.

The curing is not limited, and any method that can cure the composition is included in the scope of the present disclosure. In one embodiment, the curing is thermal curing, photocuring (such as ultraviolet curing), or the like. In one embodiment, curing is performed at a temperature of 100° C. to 150° C. for 10 minutes to 60 minutes, the curing temperature includes but is not limited to 100° C., 110° C., 120° C., 130° C., 140° C., and 150° C., the curing time includes but not limited to 10, 15, 20, 30, 40, 50, 60 minutes.

In one embodiment, the preparation method of the present disclosure further includes a step of repeatedly coating and curing the ultraviolet-absorbing resin composition on the ultraviolet-absorbing resin layer to form a plurality of ultraviolet-absorbing resin layers. As shown in FIG. 1B, the ultraviolet-absorbing resin composition is coated on the surface of substrate 10, the ultraviolet-absorbing resin composition is cured to form first ultraviolet-absorbing resin layer 21. Then, the same or different ultraviolet-absorbing resin compositions are used and the above steps are repeated to obtain second ultraviolet-absorbing resin layer 22, and finally, a finished product including two ultraviolet-absorbing resin layers 21 and 22 is obtained.

In one embodiment, the isocyanate curing agent of the ultraviolet-absorbing resin composition that is repeatedly coated and cured is different from the isocyanate curing agent of the ultraviolet-absorbing resin composition that is coated on the surface of the substrate.

The present disclosure will be described in further detail with reference to the following specific embodiments and comparative examples. However, these specific embodiments and comparative examples are in no way intended to limit the scope of the present disclosure.

### Selection of Resin

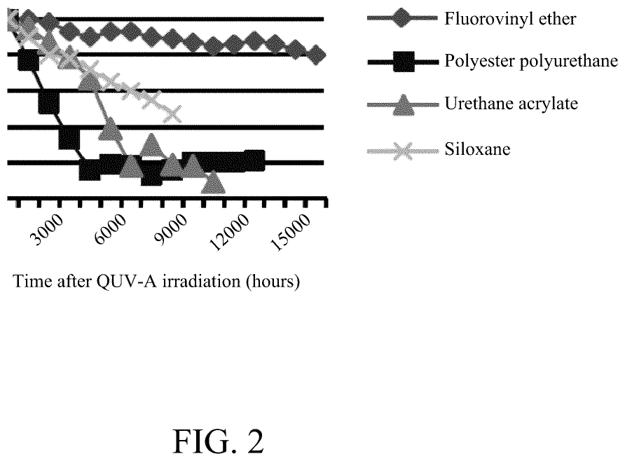

Fluoroethylene-vinyl ether (FEVE), polyester urethane, acrylic urethane, and siloxane resin were used as resin coatings respectively, and were subjected to QUV-A ultraviolet irradiation instrument, the gloss retention rates of each resin coating after long-term ultraviolet irradiation were shown in FIG. 2. From the results in FIG. 2, it can be concluded that the ultraviolet resistance of the resin coatings from high to low is FEVE>siloxane resin>acrylic urethane>polyester polyurethane. The FEVE type fluorocarbon resin coating has the best resistance to ultraviolet rays due to the fluorocarbon bonds in its structure, but it is not bound by theory.

### Example 1—Ultraviolet-Absorbing Resin

40 wt % to 50 wt % of FEVE type fluorocarbon resin (for example, DS302 series resin, purchased from Yijin Technology; Lumiflon series resin, purchased from Xusheng Technology; New Gamet-FEVE series resin, purchased from Deya Resin), 15% to 21% of HDI, 1% to 5% of benzotriazole ultraviolet absorbent (Eversorb series dyes, purchased from Yongguang Chemical), 15% to 20% of xylene, and 20% to 25% of methyl ethyl ketone were mixed to form an ultraviolet-absorbing resin composition. Then, the ultraviolet-absorbing resin composition was formed on glass by spin coating, and baked at a temperature of 120° C. for 30 minutes to curing, thereby an ultraviolet-absorbing resin was obtained.

### Examples 2 to 4—Ultraviolet-Absorbing Resin

ultraviolet-absorbing resins were prepared according to Example 1, but the HDI in the ultraviolet-absorbing resin composition was replaced with IPDI, XDI and TDI respectively. That is, a HDI curing agent, an IPDI curing agent, an XDI curing agent and a TDI curing agent were respectively used in Examples 1 to 4.

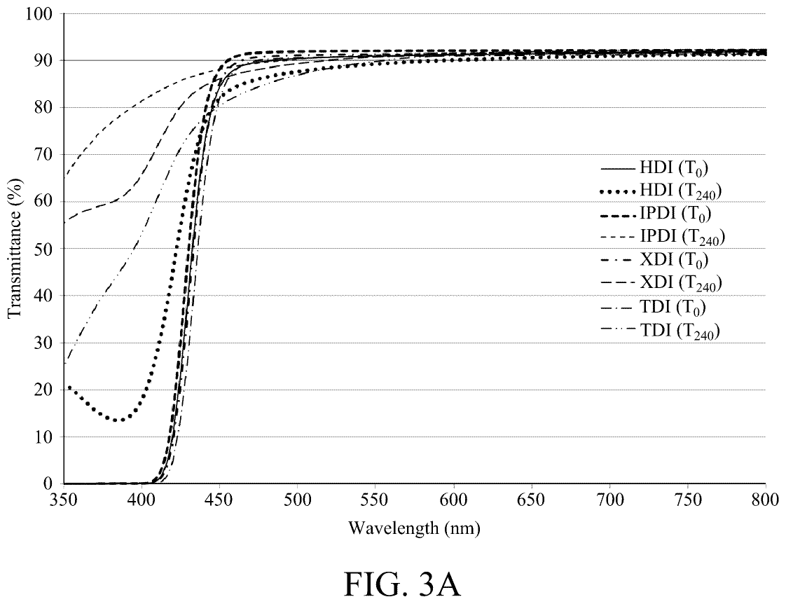

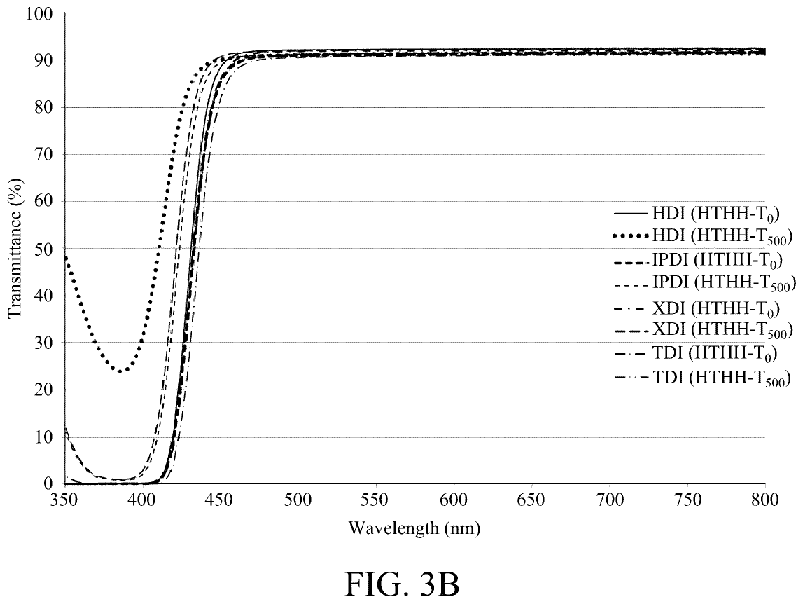

The ultraviolet-absorbing resins of the above-mentioned Examples 1 to 4 were subjected to the ultraviolet resistance test to evaluate the effects of different curing agents. The ultraviolet tolerance test was conducted with ultraviolet irradiation for 0 and 240 hours (UV wavelength: 420 nm, irradiation intensity 2.4 W/M²). After the test, the transmittance curves of each ultraviolet-absorbing resin were shown in FIG. 3A. According to FIG. 3A, Example 1, which uses the HDI curing agent has the best resistance to ultraviolet rays. The order of resistance to ultraviolet rays from high to low is Example 1 (HDI curing agent)>Example 4 (TDI curing agent)>Example 3 (XDI curing agent)>Example 2 (IPDI curing agent).

The ultraviolet-absorbing resins of the above-mentioned Examples 1 to 4 were subjected to the ultraviolet resistance test in high temperature and high humidity environment to evaluate the effects of different curing agents. The ultraviolet resistance test herein was conducted with 0 and 500 hours of ultraviolet irradiation (UV wavelength: 420 nm, irradiation intensity 2.4 W/M²). After the test, the transmittance curves of each ultraviolet-absorbing resin were shown in FIG. 3B. According to FIG. 3B, Example 4, which uses the TDI curing agent showed high resistance to ultraviolet rays in high temperature and high humidity environment, and has the best weather resistance, which can enhance the protective effect. In addition, the ultraviolet resistance (weather resistance) demonstrated in high temperature and high humidity environment from high to low are Example 4 (TDI curing agent)>Example 2 (IPDI curing agent)>Example 3 (XDI curing agent)>Example 1 (HDI curing agent).

In practical applications, an ultraviolet-absorbing resin layer can be selected or used in combination according to the ultraviolet tolerance and needs.

### Comparative Example 1

An ultraviolet-absorbing resin was prepared according to Example 1, but the fluorocarbon resin in the ultraviolet-absorbing resin composition was replaced with an acrylic resin.

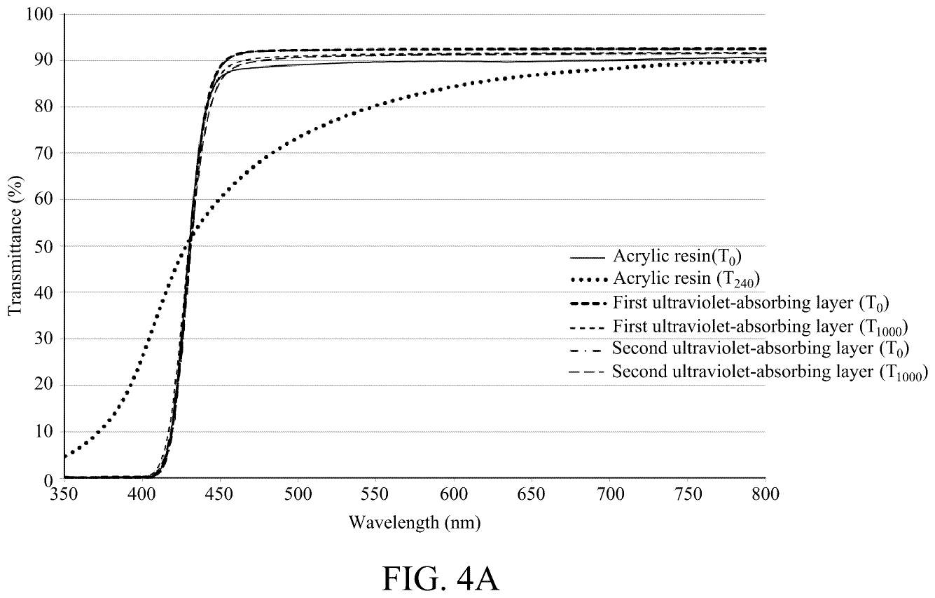

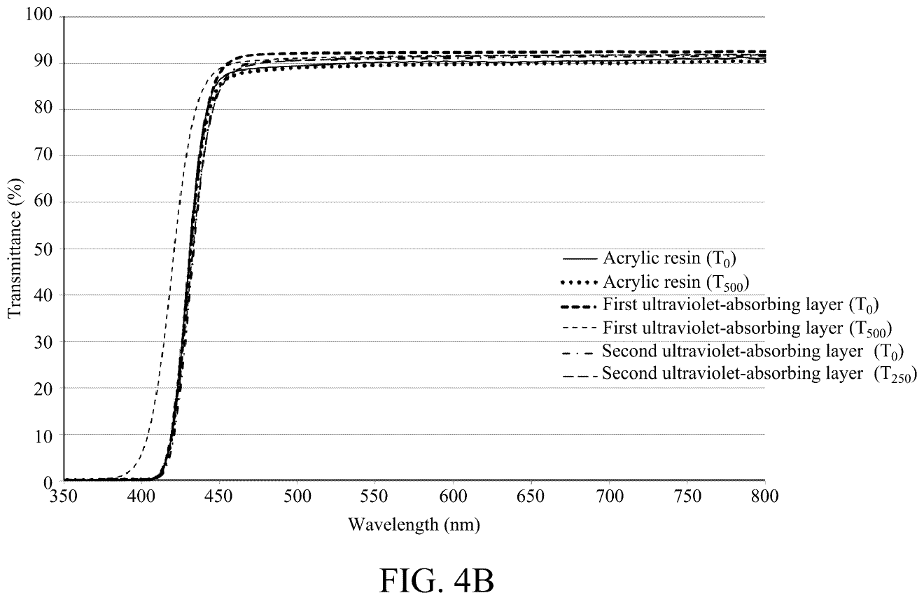

The ultraviolet-absorbing resins of the above-mentioned Example 1, Example 4 and Comparative Example 1 were subjected to the ultraviolet resistance test to evaluate the effects of different fluorocarbon resins. The ultraviolet tolerance test was conducted with 0, 240 and 1000 hours of ultraviolet irradiation (UV wavelength: 420 nm, irradiation intensity 2.4 W/M²). After the test, the transmittance curves of each ultraviolet-absorbing resin were shown in FIG. 4A. According to FIG. 4A, both the ultraviolet-absorbing resins of Example 1 (as represented by the curves of the first ultraviolet-absorbing layer as shown in FIG. 4A) and Example 4 (as represented by the curves of the second ultraviolet-absorbing layer as shown in FIG. 4A) can pass the 1000 hour ultraviolet resistance test; however, the ultraviolet-absorbing resin of Comparative Example 1 deteriorated significantly after being irradiated with ultraviolet light for 240 hours, and its transmittance for light with a wavelength of 380 nm to 410 nm was too high to meet the requirements, showing that Comparative Example 1 using the acrylic resin only has poor ultraviolet resistance.

The ultraviolet-absorbing resins of the above-mentioned Example 1, Example 4 and Comparative Example 1 were subjected to the ultraviolet resistance test in high temperature and high humidity environment to evaluate effects of different fluorocarbon resins. The ultraviolet resistance test herein was conducted with 0 and 500 hours of ultraviolet irradiation (UV wavelength: 420 nm, irradiation intensity 2.4 W/M²). After the test, the transmittance curves of each ultraviolet-absorbing resin were shown in FIG. 4B. According to FIG. 4B, the ultraviolet-absorbing resins of Example 1 (as represented by the curves of the first ultraviolet-absorbing layer as shown in FIG. 4B), Example 4 (as represented by the curves of the second ultraviolet-absorbing layer as shown in FIG. 4B) and Comparative Example 1 can still exhibit excellent ultraviolet resistance even in high temperature and high humidity environment, that is, they have excellent weather resistance.

The above-mentioned implementation modes and specific examples are not intended to limit the present disclosure, and the listed technical features or solutions can be combined with each other. The present disclosure can also be implemented or applied through other different implementations, various details recorded herein may also be subject to different changes or modifications based on different viewpoints and applications without departing from the present disclosure.

What is claimed is:

1. An ultraviolet-absorbing resin composition, comprising, based on the total weight of the ultraviolet-absorbing resin composition:
35 to 45 wt % fluorocarbon resin;
5 to 25 wt % isocyanate curing agent;
1 to 5 wt % ultraviolet absorbent; and
remaining solvent.

2. The ultraviolet-absorbing resin composition of claim 1, wherein the fluorocarbon resin comprises fluorinated ethylene repeating units as shown in Formula 1, 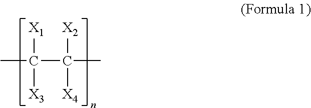
wherein,
X₁, X₂, X₃ and X₄ are each independently hydrogen, fluorine, substituted or unsubstituted C₁-C₁₂ alkyl, substituted or unsubstituted C₃-C₁₂ cycloalkyl, substituted or unsubstituted C₆-C₁₂ aryl,
n is any positive integer, and
at least one of X₁, X₂, X₃ and X₄ is fluorine or substituted by fluorine.

3. The ultraviolet-absorbing resin composition of claim 1, wherein the isocyanate curing agent is at least one selected from the group consisting of hexamethylene diisocyanate (HDI), toluene diisocyanate (TDI), cyclohexane diisocyanate (CHDI), isophorone diisocyanate (IPDI), methylene diphenyl diisocyanate (MDI), methylene dicyclohexyl diisocyanate (H12MDI), naphthalene diisocyanate (NDI), trimethylhexamethylene diisocyanate (TMDI), xylene diisocyanate (XDI), lysine diisocyanate (LDI), trimers of the said diisocyanates, triphenylmethane triisocyanate, toluene triisocyanate, and lysine triisocyanate.

4. The ultraviolet-absorbing resin composition of claim 1, wherein the ultraviolet-absorbent is at least one selected from the group consisting of azomethine compounds, indole compounds, benzotriazole compounds, triazine compounds, ketone compounds, and salicylic acid derivatives.

5. The ultraviolet-absorbing resin composition of claim 1, wherein the isocyanate curing agent is hexamethylene diisocyanate (HDI), the ultraviolet absorbent is a benzotriazole compound, and the solvent is a mixed solvent of xylene and methyl ethyl ketone.

6. The ultraviolet-absorbing resin composition of claim 1, further comprising 0.01 wt % to 2 wt % of a light stabilizer, wherein the isocyanate curing agent is toluene diisocyanate (TDI), the ultraviolet-absorbent is benzotriazole compounds, and the solvent is xylene.

7. An ultraviolet-absorbing resin formed from the ultraviolet-absorbing resin composition of claim 1, comprising: fluorocarbon resin, isocyanate curing agent and ultraviolet absorbent, wherein the average transmittance of the ultraviolet-absorbing resin for light with a wavelength of 430 nm to 680 nm is 85% or more; and for light with a wavelength of 380 nm to 410 nm, the maximum light transmittance is 1% or less and the average transmittance is 1% or less.

8. The ultraviolet-absorbing resin of claim 7, after being tested at a high temperature of 85° C. and high humidity of 85% for 500 hours, having an average transmittance of 85% or more for light with a wavelength of 430 nm to 680 nm; and for light with a wavelength of 380 nm to 410 nm, the maximum light transmittance is 1% or less and the average transmittance is 1% or less.

9. The ultraviolet-absorbing resin of claim 7, after being tested at a high temperature of 85° C. and high humidity of 85% for 1,000 hours, having an average transmittance of 85% or more for light with a wavelength of 430 nm to 680 nm; and for light with a wavelength of 380 nm to 410 nm, the maximum light transmittance is 1% or less and the average transmittance is 1% or less.

10. An ultraviolet-absorbing structure, comprising a plurality of ultraviolet-absorbing resin layers, wherein each of the ultraviolet-absorbing resin layers comprises the ultraviolet-absorbing resin of claim 7, and the isocyanate curing agents of the ultraviolet-absorbing resin in each layer are different from each other.

11. The ultraviolet-absorbing structure of claim 10, comprising a first ultraviolet-absorbing resin layer and a second ultraviolet-absorbing resin layer, wherein, the isocyanate curing agent in the first ultraviolet-absorbing resin layer is hexamethylene diisocyanate (HDI), and the isocyanate curing agent in the second ultraviolet-absorbing resin layer is toluene diisocyanate (TDI).

12. The ultraviolet-absorbing structure of claim 10, having a thickness of 2 nm to 200 μm.

13. A method of preparing ultraviolet-absorbing resin, comprising:
coating the ultraviolet-absorbing resin composition of claim 1 on the surface of a substrate; and
curing the ultraviolet-absorbing resin composition to obtain an ultraviolet-absorbing resin.

14. The method of claim 13, further comprising a step of repeatedly coating and curing the ultraviolet-absorbing resin composition on the ultraviolet-absorbing resin, to form a plurality of the ultraviolet-absorbing resin layers.

15. The method of claim 13, wherein the isocyanate curing agent of the ultraviolet-absorbing resin composition repeatedly coated and cured is different from the isocyanate curing agent of the ultraviolet-absorbing resin composition coated on the surface of the substrate.

16. The method of claim 13, wherein the coating is spin coating, dip coating, cast coating, spray coating, bead coating, rod coating, blade coating or slit coating.

17. The method of claim 13, wherein the curing is performed at a temperature of 100° C. to 150° C. for 10 minutes to 60 minutes.
